(19) United States
(12) Patent Application Publication
(10) Pub. No.: US 2003/0236710 A1
(43) Pub. Date: Dec. 25, 2003

(54) Method and system for providing online shopping assistance

(76) Inventors: Vincent Tong, Alameda, CA (US); Allen Tom, Fresno, CA (US); Jun Huang, San Jose, CA (US); Kiersten Lammerding, Sunnyvale, CA (US)

Correspondence Address: GLENN PATENT GROUP, 3475 EDISON WAY, SUITE L, MENLO PARK, CA, 94025, US

(21) Appl. No.: 10/178,478

(22) Filed: Jun. 24, 2002

(51) Int. Cl. G06F 17/60

(52) U.S. Cl. 705/26

(57) ABSTRACT

The method and system of the present invention provides instant online shopping assistance comparison shopping experience that enables online shoppers to confidently and conveniently shop online, knowing that they are getting the best deal for a product or service. The system and method of the present invention provides a comprehensive, multi-channel list of online and offline providers of a desired item as well as comparison information of providers of the desired product or service. Thus, the system and method of the present invention saves shopping time for bargain-seeker shoppers, attracts more physical product/service retail outlets to join online shopping services, and retains the existing online product/service providers.

### BACKGROUND OF THE INVENTION

1. Field of the Invention

The invention relates to online shopping. More particularly, the invention relates to a system and a family of methods that provide contextual online shopping assistance based on user's search input information.

2. Description of Related Technology

Presently, online shopping services provide information about only the online product or service provider that an online shopper is browsing. Such online providers may have only a storefront WEB access, and usually do not have a physical retail store. Such information does not include information about other providers of the product or service that the shopper is interested in, such as price comparison, provider rating, and/or provider review, because such information is not generated based on information received from other online and offline providers. Therefore, bargain-seeker shoppers do not fully trust current online product or service pricing information, and majority of such shoppers end up using the information they receive from online searching to local physical retail providers for final price comparison. Often, such bargain-seeker shoppers get a better deal or competitive price from a local physical provider and eventually do the shopping offline. Local physical retail providers further attract shopper because they provide in-store product touch and feel experience, quick delivery and pickup, and convenient return policies.

Current online shopping services do not provide instant detailed information about offline providers of a desired product or service, such as in-store pick up policies, in-store return policies, and other detailed information.

Current online shoppers have to leave a provider's WEB page that they are browsing and activate a different search to obtain comparison information about other providers of the desired product or service. This distracts the shoppers and slows down their search and shopping process.

There is a need, therefore, for online shopping services that provide online shoppers the ability to find the most competitive price for a desired product or service and provide online comparison information of online and offline providers of the desired product or service, which may be generated in one integrated search and may be provided on one screen. There is also a need for online shopping services that attract and retain offline product or service providers by highlighting their detailed information and features online.

### SUMMARY OF THE INVENTION

One presently preferred embodiment of the invention provides a system and a method for providing online shopping assistance that includes monitoring search input received from a user for browsing a provider of a desired item, determining at least one shopping tool or service related to the desired item, and recommending the shopping service to the user.

Another presently preferred embodiment of the invention provides a system and a method for providing instant online comparison information about a plurality of online and offline providers of the desired product or service.

### BRIEF DESCRIPTION OF THE DRAWINGS

FIG. 1 shows a flow chart for a method of providing online shopping assistance according to one embodiment of the present invention; and

FIG. 2 shows a representation of a shopping assistance presentation according to one embodiment of the present invention.

### DETAILED DESCRIPTION OF THE INVENTION

The invention contemplates new and unique system and a family of methods for online shopping, which may be implemented in a network of computer systems, such as the Internet. A computer system may include user terminals, storage devices, processing units, input and output devices, and networking devices and programs.

Online shoppers may include those shoppers who both search and shop a product or service online. These shoppers usually do not check the online price information with the price information offered by local product/service providers for getting a bargain price. One the other hand, online shoppers may also include those bargain-seeker, price-driven shoppers who usually take the information they obtain from online search results to offline local providers, looking for a special offers, sales, and/or coupons. Therefore, current online shopping services lose revenue unless they attract and retain more online shoppers by providing them instant and comprehensive information about both online and offline providers of a desired product or service that an online shopper is interested in, in response to a search request for the desired product or service and on the same screen that the shopper is browsing a provider of the desired product or service.

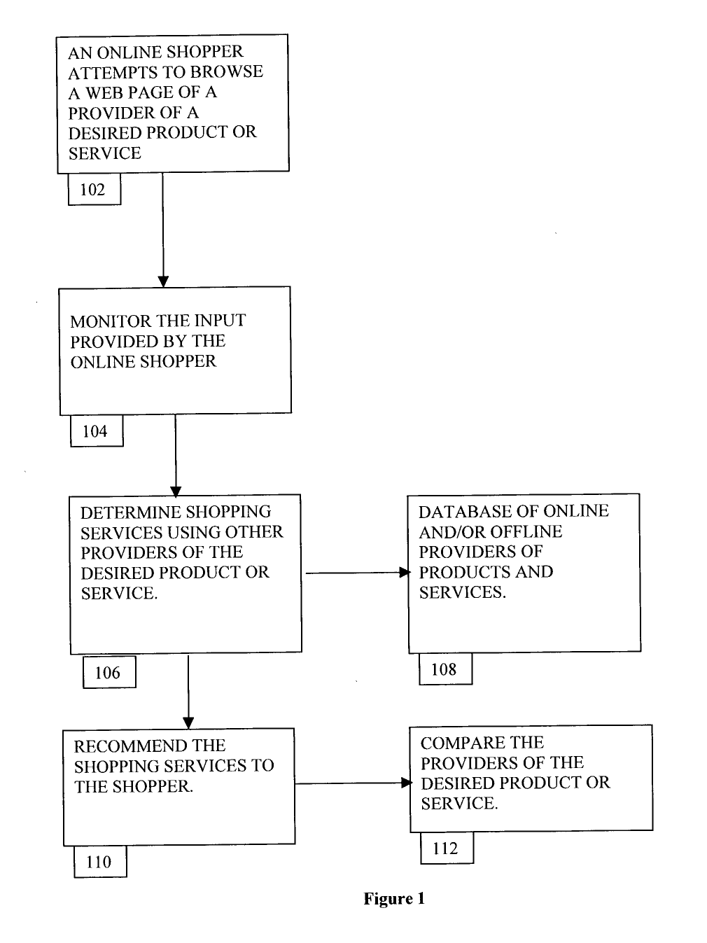

FIG. 1 is a block diagram for a method for providing online shopping assistance according to a preferred embodiment of the invention. An online shopper may browse a WEB page of a provider of a desired product or service, in step 102. A shopper may request for a desired product or service based on a category of products or services, such as toys, electronics, or cleaners. The shopper may also request for a product or service based on a name or an identification code of a specific product or service, such as a game, a television set, or a carpet cleaner. A request for a product or service may be also based on a name or an identification code of a product or service provider, such as a specific toy store, an electronics distributor, or a cleaner. A search request for a product or service may be limited to a geographical area. A desired geographical area may be identified by a shopper's city and state, zip code, and/or a target location. A geographical area may be limited to a proximity range, such as a default or a user-defined search radius about a target location.

In step 104, the search input or some identification information of a provider of a product or service that a shopper attempts to view or browse is monitored. This monitoring may include, for example, tracking the URL address of the provider that the shopper attempts to browse. This tracking may include determining a context from search request input and/or from the identification information of the provider that the shopper is browsing.

After determining a context from an online search request for a desired product or service or from information about the provider of the desired product or service that the shopper is browsing, according to one embodiment of the present invention, a search is conducted for other online and offline providers of the desired product or service. In step 106, the database 108, which contains information about online and offline providers who are partners with the online shopping service, is searched.

The providers in database 108 may include “pure-play e-tailers” online providers with a WEB storefront, which may not have physical retail outlets and may allow the shoppers to trade with them only through online shopping. The providers in database 108 may also include the offline “brick-&-mortar” providers, which have physical retail outlets but no WEB storefront, such as local mom-&-pop stores. The providers in database 108 may also include the offline “click-&-mortar” providers, which have physical retail outlets as well as WEB storefront. These offline providers may allow the shoppers to trade with them either online or offline.

After determining information about other online or offline providers of the desired product or service, a number of shopping tools or services may be determined and presented to the shopper. Such shopping tools or services may include information specific to other providers of the desired product or service, such as price, special offers, coupons, rating, professional and/or user review, proximity, and/or pickup and or return policies. Such shopping tools may also include comparison information on providers of the desired product or service.

In step 110, the list of other providers of the desired product or service as well as the shopping tools or services for assisting the shopper may be recommended to the shopper. In one embodiment, the shopper may be notified first about availability of such shopping assistance information, if the shopper has not disabled this feature. After a shopper receives shopping assistance information, he or she may choose to hide all or some part of the recommended information. A shopper may provide feedback about the recommended information and service by, for example, sending an e-mail to the online shopping service. Such feedback information may be used to automatically update or enhance the database 108.

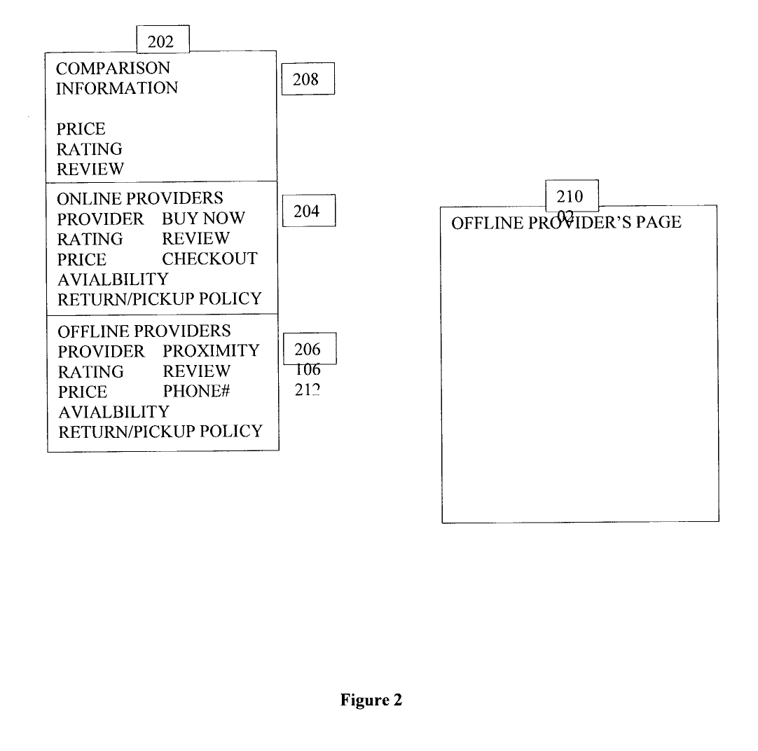

FIG. 2 presents an exemplary shopping assistance presentation page 202. A shopping assistance page may include a first portion 204, pertaining to the online providers that carry the desired product or service, and a second portion 206, pertaining to the offline providers that carry the same product or service. The above two portions may be combined to provide a comprehensive list of providers for a desired product or service.

When an online shopper selects an offline product service provider from the portion 206 of the shopping assistance page 202, the shopper may receive detailed information about the selected offline provider. A shopping assistance page 202 may contain a direct link to a provider page 210 that may provide detailed information for a selected offline provider. Such detailed information may include a provider's business name, address, phone number, photo, map, working hours, rating, user and/or expert reviews, driving direction, sales and/or coupons, and in-store pickup and/or return policies of online purchases. The offline providers may regularly update their information.

A shopping assistance page 202 may also include a third portion 208 that may provide comparison information of both online and offline providers of the desired product or service. In step 112, the providers of a desired product or service may be compared to provide provider comparison information. The comparison information may be based on providers rating, sales/coupons, product or service price, product or service availability, user review, professional/expert review, and/or return and/or pickup policies. Therefore, the bargain-seeker, price-driven, and sales-fanatic shoppers may conveniently get the providers comparison information online, and may confidently do more online shopping. This attracts more shoppers to do online shopping, attracts more “brick-&-mortar” offline providers to join online shopping services, and retains more “pure-play e-tailer” online providers.

Preferably, the recommended information may be presented on the same screen that the shopper is currently browsing a provider of the desired product or service, without requiring the shopper to leave the provider's WEB site or activating another comparison-shopping search engine.

The list of offline providers of a product or service may be based on a target geographical location. Shoppers may choose such target locations to be their home, work, or other locations. A shopper may choose one of several target locations, which may have been already created and stored for future use. The list of offline providers may be prioritized based on a desired factor, such as proximity to a target location, price, rating, or user and/or expert review.

In another embodiment of the invention, a provider locator allows searching for a desired provider, which may include an A-Z directory of providers, a directory of product/service categories, and/or a provider department page.

The method and system of the invention provides instant online shopping assistance that creates a comparison shopping experience that enables online shoppers to confidently and conveniently shop online, knowing that they are getting the best deal for a product/service based on online caparison information of online and offline product/service providers. The system and method of the present invention provides a comprehensive and multi-channel shopping assistant, provides an integrated list of online and offline providers, and provides providers comparison information about providers of a desired product or service.

Thus, the system and method of the present invention saves shopping time for bargain-seeker shoppers, attracts more physical product/service retail outlets to join online shopping services, and retains the online product/service providers.

Accordingly, although the invention has been described in detail with reference to particular preferred or exemplary embodiments, persons possessing ordinary skill in the art to which this invention pertains will appreciate that various modifications and enhancements may be made without departing from the spirit and scope of the claims that follow.

1. A method for providing online shopping assistance, comprising the steps of:
monitoring input from a user for browsing a provider of an item;
determining at least one shopping service related to the item; and
providing the at least one shopping service to the user.

2. The method of claim 1, wherein the monitoring step includes monitoring a URL address of the provider.

3. The method of claim 1, wherein the monitoring step includes retrieving a context from the input.

4. The method of claim 3, wherein the determining step is based on the context.

5. The method of claim 1, wherein the providing step includes providing a notification to the user about the at least one shopping service before providing the at least one shopping service to the user.

6. The method of claim 5, wherein the user may disable receiving the notification.

7. The method of claim 1, wherein the user may disable the providing the at least one shopping service.

8. The method of claim 1, wherein the user may hide the at least one shopping service.

9. The method of claim 1, wherein the user may provide a feedback about the at least one shopping service.

10. The method of claim 9, wherein the feedback may be via e-mail.

11. The method of claim 1, wherein the providing step includes providing the at least one shopping service on a WEB page that the user is browsing.

12. The method of claim 1, wherein the providing at least one shopping service includes providing information about at least another provider of the item.

13. The method of claim 12, wherein the providing at least one shopping service further includes providing provider comparison information.

14. The method of claim 13, wherein the provider comparison information includes provider-rating information.

15. The method of claim 13, wherein the provider comparison information includes in-store pickup and return policies for an offline provider.

16. The method of claim 13, wherein the provider comparison information includes provider review information.

17. The method of claim 13, wherein the provider comparison information includes provider certification information.

18. The method of claim 12, wherein the information includes a special offer for the item.

19. The method of claim 12, wherein the information includes coupon-availability information for the item.

20. A computer readable medium embodying a method for providing online shopping assistance, the method comprising the steps of:
monitoring input from a user for browsing a provider of an item;
determining at least one shopping service related to the item; and
providing the at least one shopping service to the user.

21. A system for providing online shopping assistance, comprising:
at least one user terminal;
at least one database containing information about online and offline providers;
means for monitoring input from a user for viewing a provider of an item;
means for determining at least one shopping service related to the item; and
means for providing the at least one shopping service to the user.

22. The computer system of claim 21, further implemented on a network environment.

23. The computer system of claim 22, wherein the network environment includes Internet.
